(19) United States
(12) Patent Application Publication
(10) Pub. No.: US 2018/0264598 A1
(43) Pub. Date: Sep. 20, 2018

(54) CONSTANTLY VARYING HATCH FOR ADDITIVE MANUFACTURING

(71) Applicant: GENERAL ELECTRIC COMPANY, Schenectady, NY (US)

(72) Inventor: Justin MAMRAK, Loveland, OH (US)

(21) Appl. No.: 15/459,941

(22) Filed: Mar. 15, 2017

(51) Int. Cl. B23K 26/342; B33Y 10/00; B33Y 30/00; B23K 15/00

(52) U.S. Cl. CPC B23K 26/342; B33Y 10/00; B23K 2203/05; B23K 15/0086; B33Y 30/00

(57) ABSTRACT

An improved scanning strategy, having a waveform hatch pattern for scanning an energy source during an additive manufacturing build process. A waveform hatch pattern is formed on each layer of the build so as to increase the variance between layers and/or improve the microstructure of the completed component. In one aspect, a first layer is formed by scanning a laser in a series of hatch lines formed as a first pattern that oscillates about an axis. Each subsequent layer is formed as a series hatch lines formed in a pattern that is varied in geometry from a previous and subsequently formed layer. By varying the pattern when forming each layer, the desired variance in each layer can be achieved.

The disclosure relates to an improved method of producing components using an additive manufacturing technique. The disclosure provides an improved method of producing components, some of examples of which comprise: improved microstructure, decreased manufacturing time, decreased cost, decreased waste of materials. In particular, the disclosure relates to a process of scanning a laser during an additive manufacturing build process.

### BACKGROUND

Additive manufacturing (AM) techniques may include electron beam freeform fabrication, laser metal deposition (LMD), laser wire metal deposition (LMD-w), gas metal arc-welding, laser engineered net shaping (LENS), laser sintering (SLS), direct metal laser sintering (DMLS), electron beam melting (EBM), powder-fed directed-energy deposition (DED), and three dimensional printing (3DP), as examples. AM processes generally involve the buildup of one or more materials to make a net or near net shape (NNS) object in contrast to subtractive manufacturing methods. Though “additive manufacturing” is an industry standard term (ASTM F2792), AM encompasses various manufacturing and prototyping techniques known under a variety of names, including freeform fabrication, 3D printing, rapid prototyping/tooling, etc. AM techniques are capable of fabricating complex components from a wide variety of materials. Generally, a freestanding object can be fabricated from a computer aided design (CAD) model. As an example, a particular type of AM process uses an energy beam, for example, an electron beam or electromagnetic radiation such as a laser beam, to sinter or melt a powder material and/or wire-stock, creating a solid three-dimensional object in which a material is bonded together.

Selective laser sintering, direct laser sintering, selective laser melting, and direct laser melting are common industry terms used to refer to producing three-dimensional (3D) objects by using a laser beam to sinter or melt a fine powder. For example, U.S. Pat. No. 4,863,538 and U.S. Pat. No. 5,460,758 describe conventional laser sintering techniques. More specifically, sintering entails fusing (agglomerating) particles of a powder at a temperature below the melting point of the powder material, whereas melting entails fully melting particles of a powder to form a solid homogeneous mass. The physical processes associated with laser sintering or laser melting include heat transfer to a powder material and then either sintering or melting the powder material. Electron beam melting (EBM) utilizes a focused electron beam to melt powder. These processes involve melting layers of powder successively to build an object in a metal powder.

AM techniques, examples of which are discussed above and throughout the disclosure, may be characterized by using a laser or an energy source to generate heat in the powder to at least partially melt the material. Accordingly, high concentrations of heat are generated in the fine powder over a short period of time. The high temperature gradients within the powder during buildup of the component may have a significant impact on the microstructure of the completed component. Rapid heating and solidification may cause high thermal stress and cause localized non-equilibrium phases throughout the solidified material. Further, since the orientation of the grains in a completed AM component may be controlled by the direction of heat conduction in the material, the scanning strategy of the laser in an AM apparatus and technique becomes an important method of controlling microstructure of the AM built component. Controlling the scanning strategy in an AM apparatus is further crucial for developing a component free of material defects, examples of defects may include lack of fusion porosity and/or boiling porosity.

FIG. 1 is schematic diagram showing a cross-sectional view of an exemplary conventional system 110 for direct metal laser sintering (DMLS) or direct metal laser melting (DMLM). The apparatus 110 builds objects, for example, the part 122, in a layer-by-layer manner (e.g. layers L1, L2, and L3, which are exaggerated in scale for illustration purposes) by sintering or melting a powder material (not shown) using an energy beam 136 generated by a source such as a laser 120. The powder to be melted by the energy beam is supplied by reservoir 126 and spread evenly over a build plate 114 using a recoater arm 116 travelling in direction 134 to maintain the powder at a level 118 and remove excess powder material extending above the powder level 118 to waste container 128. The energy beam 136 sinters or melts a cross sectional layer (e.g. layer L1) of the object being built under control of the galvo scanner 132. The build plate 114 is lowered and another layer (e.g. layer L2) of powder is spread over the build plate and object being built, followed by successive melting/sintering of the powder by the laser 120. The process is repeated until the part 122 is completely built up from the melted/sintered powder material. The laser 120 may be controlled by a computer system including a processor and a memory. The computer system may determine a scan pattern for each layer and control laser 120 to irradiate the powder material according to the scan pattern. After fabrication of the part 122 is complete, various post-processing procedures may be applied to the part 122. Post processing procedures include removal of excess powder, for example, by blowing or vacuuming, machining, sanding or media blasting. Further, conventional post processing may involve removal of the part 122 from the build platform/substrate through machining, for example. Other post processing procedures include a stress release process. Additionally, thermal and chemical post processing procedures can be used to finish the part 122.

The abovementioned AM processes is controlled by a computer executing a control program. For example, the apparatus 110 includes a processor (e.g., a microprocessor) executing firmware, an operating system, or other software that provides an interface between the apparatus 110 and an operator. The computer receives, as input, a three dimensional model of the object to be formed. For example, the three dimensional model is generated using a computer aided design (CAD) program. The computer analyzes the model and proposes a tool path for each object within the model. The operator may define or adjust various parameters of the scan pattern such as power, speed, and spacing, but generally does not program the tool path directly. One having ordinary skill in the art would fully appreciate the abovementioned control program may be applicable to any of the abovementioned AM processes. Further, the abovementioned computer control may be applicable to any subtractive manufacturing or any pre or post processing techniques employed in any post processing or hybrid process.

The above additive manufacturing techniques may be used to form a component from stainless steel, aluminum, titanium, Inconel 625, Inconel 718, Inconel 188, cobalt chrome, among other metal materials or any alloy. For example, the above alloys may include materials with trade names, Haynes 188®, Haynes 625®, Super Alloy Inconel 625™, Chronin® 625, Altemp® 625, Nickelvac 625, Nicrofer® 6020, Inconel 188, and any other material having material properties attractive for the formation of components using the abovementioned techniques.

In the abovementioned example, a laser and/or energy source is generally controlled to form a series of solidification lines (hereinafter interchangeably referred to as hatch lines, solidification lines and raster lines) in a layer of powder based on a pattern. A pattern may be selected to decrease build time, to improve or control the material properties of the solidified material, to reduce stresses in the completed material, and/or to reduce wear on the laser, and/or galvanometer scanner and/or electron-beam. Various scanning strategies have been contemplated in the past, and include, for example, chessboard patters and/or stripe patterns.

One attempt at controlling the stresses within the material of the built AM component involves the rotation of stripe regions containing a plurality of adjoining parallel vectors, as solidification lines, that run perpendicular to solidification lines forming the boundaries of the stripe region. for each layer during an AM build process. Parallel solidification lines, bounded by and perpendicular to a stripe, are rotated for each layer of the AM build. One example of controlling the scanning strategy in an AM apparatus is disclosed in U.S. Pat. No. 8,034,279 B2.

FIGS. 2 and 3 represent the abovementioned rotating stripe strategy. The laser is scanned across the surface of a powder to form a series of solidification lines 213A, 213B. The series of solidification lines form a layer of the build and are bound by solidification lines in the form of stripes 211A, 212A and 211B, 212B that are perpendicular to the solidification lines 213A and 213B forming the boundaries of each stripe region. The stripe regions bounded by solidification lines 211A and 212A form a portion of a larger surface of the layer to be built. In forming a part, a bulk of the part cross section is divided into numerous stripe regions (regions between two solidified stripes containing transverse solidification lines). A stripe orientation is rotated for each layer formed during the AM build process as shown in FIGS. 2 and 3. A first layer may be formed with a series of parallel solidification lines 213A, in a stripe region, formed substantially perpendicular to and bounded by solidified stripes 211A. In a subsequent layer formed over the first layer, the stripes 211B are rotated as shown in FIG. 3. By creating a stripe boundary for the solidified lines 213A and 213B through a set of solidified stripes 211B and 212B that are rotated with respect to the previous layer, solidification lines 213B, which are be formed perpendicular to and are bounded by stripes 211B are also be rotated with respect the solidification lines 213A of the previous layer.

As shown in FIGS. 4 and 5, a built AM component includes a plurality of layers 215, 216, 217. When built using the abovementioned strategy, a first layer 217 may be divided by software into several stripe regions bounded by, stripes 257 and 277 formed as solidification lines. The stripes 257 and 277 may form a boundary for individually formed parallel adjoining vectors or solidification lines 267. The surface of the part includes a plurality of stripes covering the surface to be built. As shown in FIG. 5, each stripe region is bounded by solidified stripes 257 and 277 in layer 217 form a boundary for a series of parallel solidified lines 267. The parallel solidification lines 267 are perpendicular to the solidified stripe boundaries 257 and 277. The stripes are oriented at a first angle in layer 217 with the perpendicular solidification lines 267 being formed substantially perpendicular to the stripes 257 and 277. The stripe region bound by solidified stripes 256 and 257 on a second layer 216 are angled with respect to the solidified stripe boundaries 257 and 277 on previous layer 217. Accordingly, solidification lines 266 that run perpendicular to solidified stripes 256 and 276 are also be angled with respect to the solidification lines 267 on previous layer 217. As the build progresses, a next layer having stripes 265 and 275 on a third layer 215 are angled with respect to stripes 257 and 277 on layer 217; and stripes 256 and 276 on layer 216.

Even with the abovementioned rotating stripe strategy, the need exists to further create variance in each layer. By employing the various embodiments disclosed, build efficiency can be further increased by preventing unnecessary jumps of the energy source, preventing unnecessary on/off transitions of the laser and/or improving control and/or efficiency of heat buildup within the layer. Further the microstructure of the part can be altered by creating each solidification line as a waveform.

### SUMMARY OF THE INVENTION

One challenge associated with laser based AM is producing a desired melt pattern in the powder while maintaining a desired speed of the build process. The buildup of heat within the powder and fused material during a build is a concern, as various material defects may occur if too much heat is built up in the material during an AM process and/or if insufficient heat is built up to properly fuse the powder. Since variance of the scan pattern in each build layer is generally desirable during an AM build, a waveform shaped scan pattern is used to create variance in the AM build layers, and by controlling the speed of the laser, the laser power, and the period, frequency, and amplitude of the waveform scan pattern, desirable material properties and efficiency of the build is achieved.

The disclosure relates to an improved scanning strategy, having a waveform hatch pattern for scanning a laser during an AM build process. When controlling the laser during the build process according to one embodiment, a waveform hatch pattern is formed on each layer so as to increase the variance between layers and improve the microstructure of the completed component. In one aspect, a first layer is formed by scanning a laser in a series of hatch lines formed as a smooth repetitive oscillation (e.g. as a sinusoidal wave). Each subsequent layer may have the series hatch lines formed as a differing sinusoidal and/or smooth repetitive oscillating pattern. For example, any one or a combination of the amplitude, frequency, angular frequency and/or phase of the sinusoidal pattern may be varied in each layer of the build. By varying the pattern when forming each layer, the desired variance in each layer can be achieved.

The abovementioned sinusoidal solidification patterns may be formed across the entire surface of the layer of the build. Further, the surface of the build may be divided into a series of stripe regions, and a series of sinusoidal solidification patterns may be formed within each stripe region.

Using the techniques discussed below, build efficiency and quality can be increased by preventing unnecessary jumps of the energy source, preventing unnecessary on/off transitions of the laser and/or by improving efficiency of heat buildup within the layers of the build. In the case of multiple lasers and/or energy sources being used, the disclosed scanning scheme may be used to further improve the AM build by employing various strategies for the use of multiple energy sources (e.g. lasers).

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a side view and top view diagram of a conventional additive manufacturing technique used to form at least part of a component;

FIG. 2 is a top view depicting a conventional hatch and stripe pattern used to form at least a part of a component;

FIG. 3 is a top view depicting a conventional hatch and stripe pattern used to form at least a part of a component;

FIG. 4 is a perspective view, depicting example layers of component build during a conventional AM process;

FIG. 5 is a top view of the individual layers shown in FIG. 4, depicting a conventional hatch and stripe pattern used to form at least a part of a component;

FIG. 6 is a top view depicting a repetitive oscillation hatch pattern used to form at least a part of a component in accordance with one aspect of the disclosure;

FIG. 7A is a top view depicting a repetitive oscillation hatch pattern used to form at last a portion of a component in accordance with one aspect of the disclosure;

FIG. 7B is an enlarged view of section A of FIG. 7A;

FIG. 8 is a perspective view, depicting example layers of component build during an AM process in accordance with one aspect of the disclosure;

FIG. 9 is a top view depicting exemplary repetitive oscillation hatch patterns used to form at least a part of each of the layers shown in FIG. 8, in accordance with one aspect of the disclosure;

FIG. 10 is a top view depicting repetitive oscillation hatch patterns and an example path of the energy source in accordance with one aspect of the disclosure;

FIG. 11 is a top view depicting repetitive oscillation hatch patterns and an example path of the energy source in accordance with one aspect of the disclosure;

FIG. 12 is a perspective view, depicting example layers of component build during an AM process in accordance with one aspect of the disclosure;

FIG. 13 is a top view depicting a repetitive oscillation hatch and stripe pattern used to form at least a part of a component in accordance with one aspect of the disclosure;

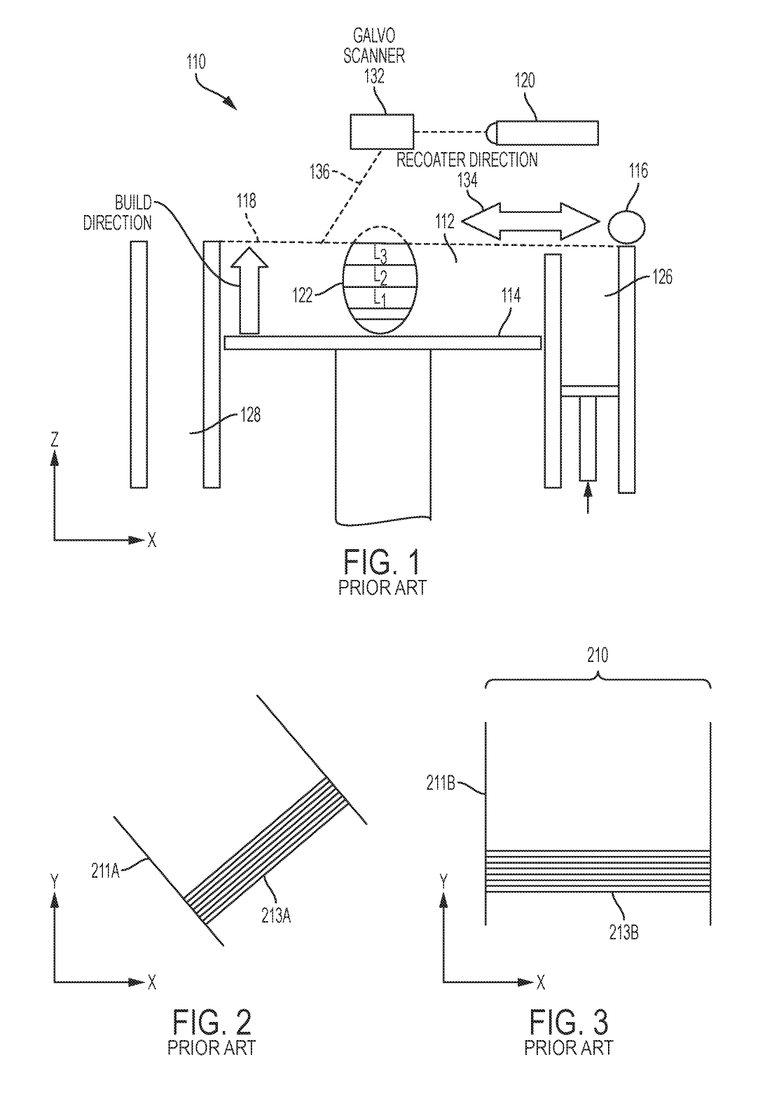

### DETAILED DESCRIPTION

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

When using any of the abovementioned AM techniques to form a part by at least partially melting a powder, a scan or mark of the laser across the powder material, in a raster scan fashion is used to create hatch scans (hereinafter referred to interchangeably as solidification lines, hatch scans, rasters and/or scan lines). During an AM build, the abovementioned raster scans are used to form the bulk of a part cross section. Contour scans, may further be used to outline the edges of the part cross section. During a raster scan process, the energy source or laser is turned on in regions where a solid portion of the AM build is desired, and switched off, defocused and/or decreased in power where melt formation of the object's cross section in that layer is not desired. These hatch scans are repeated along adjacent lines (e.g. 213A and 213B in FIG. 2) for example, to form a single melted and fused cross section of the object to be built, while the contour scans create a discrete border or edge of the part. In the example AM apparatus using a powder bed, once the melt formation of one cross section of the object being built is completed, the apparatus coats the completed cross-sectional surface with an additional layer of powder. The process is repeated until the object is complete.

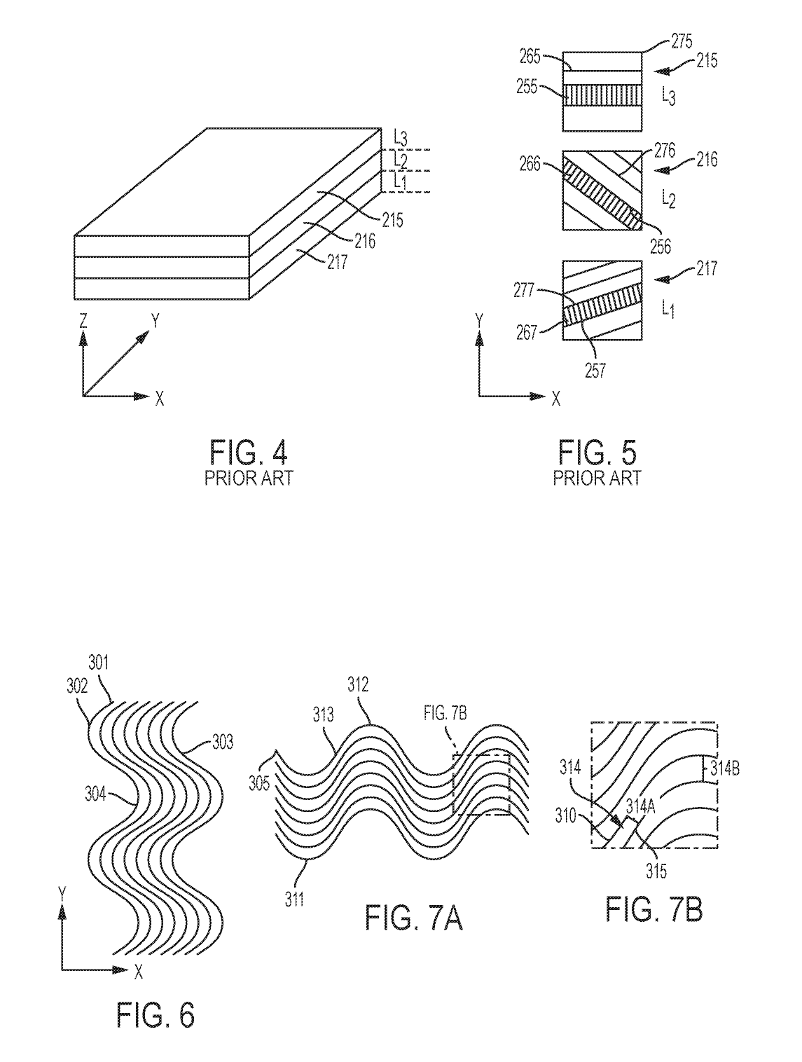

FIGS. 6 and 7, represent the scan pattern of one embodiment, wherein an energy source, such as a laser for example, is used to form a series of solidification lines (e.g. 301 and 305) in the form of smooth repetitive oscillating patterns, such as in a sinusoidal shaped path, for example. The scan pattern and solidification lines are formed in a pattern that oscillates about an axis as shown in FIGS. 6 and 7. The pattern may be selected to improve the stresses, variance in the build, control crystal growth, and/or control/improve microstructure within the material during a build process and/or to improve efficiency of the build process. The scan pattern shown in FIGS. 6-13 represent a layer wise build process having at least partially melted and subsequently solidified powder that has been fused using an energy source such as a laser or electron-beam, for example. FIGS. 6 and 7 represent an exemplary series of solidification lines that are at least partially melted and solidified by any of the abovementioned energy sources. Each of the series of solidification lines may be formed as a partially fused region across the entire layer of powder on a portion of a component to be built. Each series of solidification lines may also be bounded by a contour scan (e.g. a sloping portion of the component being built), may be bounded by the edge of the component being built, and/or the surface to be built may be divided into stripe regions and the solidification lines may be formed within the stripe region (discussed further below).

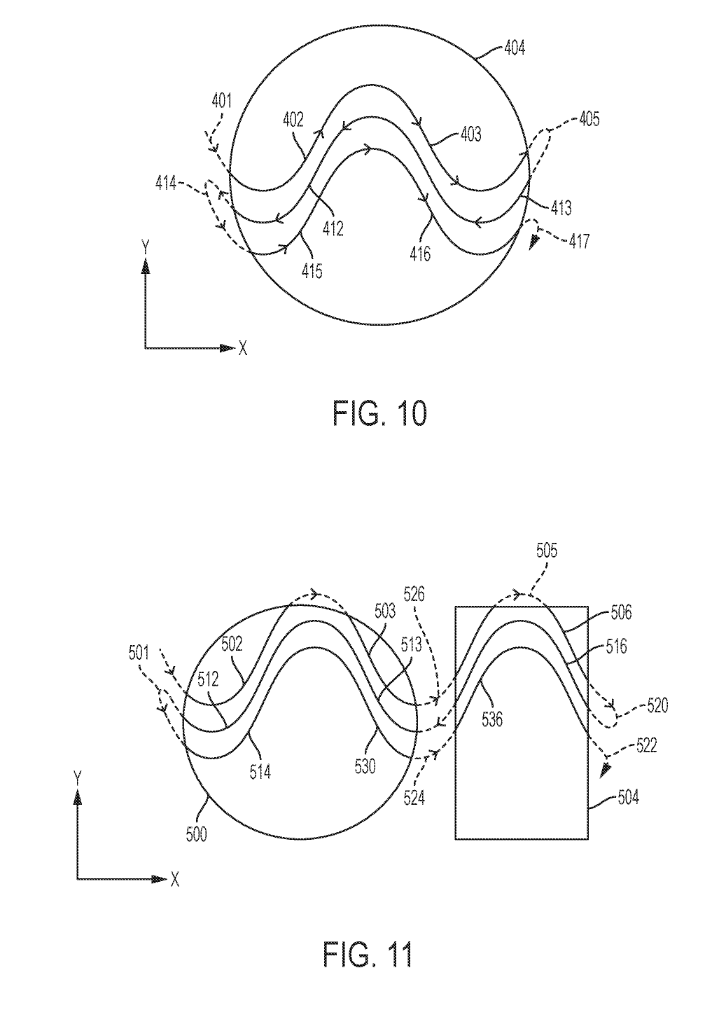

When employing the scan strategy according to one embodiment at least a partially fused region may be formed on a first layer of powder. As shown in FIG. 6, the first layer may be formed as series of curved individual solidification lines 301 formed in a pattern that oscillates about an axis. The curved solidification lines 301 may, for example, be formed as sinusoidal shaped curved solidification lines. When forming the first layer, adjacent solidification lines may be formed subsequently, prior to, or simultaneously with the formation of curved solidification line 301. In one example, as shown in FIGS. 10 and 11, each solidification line may be formed in a path following the desired curved oscillating pattern where solidification of the powder is desired. The energy source may then be turned off, defocused, and/or reduced in power (as represented by broken lines in FIGS. 10 and 11, for example) when a desired boundary is reached during the component build. After a boundary is reached and the energy source de-powered (e.g. is turned off, defocused, and/or reduced in power) the energy source scanning path may then switch direction and subsequently form the next adjacent curved solidification line following a substantially similar path to the previously formed solidification line.

When forming the adjacent curved solidification lines discussed above, a laser and/or energy source may adjusted to control the amount of powder melted along a solidification line; accordingly, a melting width and depth of each solidification line may be controlled. When the laser melts powder corresponding to solidification line 301, the material in the portion between solidification lines may not have cooled and the thin line of powder between curved solidification line 301 and the previous or subsequently formed adjacent curved solidification line may at least partially melt. The molten material in the curved solidification line 301 may fuse with the previously or subsequently formed curved solidification line and the molten material may fuse with the material bordering or other solidification lines formed in the powder. The energy source and/or laser may also be controlled so that the heat radiating from the curved solidification line 301 and a previously formed or subsequently formed curved solidification line may cause the thin line of powder between the adjacent solidification lines to sinter together without melting. Further, the scanning of the energy source and/or laser may be controlled to cause the thin line of powder between the solidification lines 301, and a previously or subsequently formed solidification line to remain unfused without sintering and/or melting.

When forming a subsequent layer of the AM build (e.g. as shown in FIG. 7), a subsequent layer of powder is distributed over the surface of the abovementioned fused region. Based on the geometry of the AM part being built, a second series of adjacent individual curved solidification lines 305 may be formed in the powder. While not limited as such, the axis about which the oscillating pattern is formed when forming the second series of curved solidification lines may be rotated with respect to the previously formed solidification lines. Further, either in combination with or as an alternative, the second series of solidification lines may also be varied in geometry. As an example, when forming the curved solidification lines along a pattern that is a sinusoidal pattern, any one or a combination of the direction, amplitude, frequency, angular frequency and/or phase of the sinusoidal pattern may be varied in each layer of the build.

When forming either of adjacent series of solidification lines as shown in FIGS. 6 and 7, for example, the distance between the adjacent curved solidification lines may vary. For instance, the distance between solidification lines at a peak amplitude of the pattern (e.g. 302, 304, 311, and 312) may be greater than a distance between the solidification lines at the axis about which the pattern oscillates (e.g. 303 and 313). FIG. 7B shows a magnified portion of the exemplary pattern shown in FIG. 7A. When forming a layer of the build, it may be desired to control the effects each formed solidification line has on the surrounding material, a previously or subsequently formed layer, and/or on any previously or subsequently formed solidification lines on the layer. For example, when the energy source melts powder corresponding to solidification line 310, the material 314 in the portion between solidification lines 310 and 315 may not have cooled and the thin line of powder 314 between curved solidification line 310 and the next formed adjacent curved solidification line 315 may at least partially melt. The molten material in the curved solidification line 310 may fuse with the next formed curved solidification line 315 and the molten material may fuse with the material bordering (e.g. 314) or other solidification lines formed in the powder. The energy source and/or laser may also be controlled so that the heat radiating from the curved solidification line 310 and a next formed curved solidification line 315 may cause the thin line of powder 314 between the adjacent solidification lines to sinter together without melting. Further, the scanning of the energy source and/or laser may be controlled to cause the thin line of powder between the solidification lines 310 and next formed solidification line 315 to remain unfused without sintering and/or melting.

It may be desirable to control the melt characteristics as described above, the varying distance between adjacent solidification lines may need to be compensated for to achieve a uniform effect on the material between the solidification lines (e.g. 314) and/or on the next or subsequent solidification line (e.g. 315). For example, since a distance is greater between solidification lines 310 and 315 at a portion of the pattern 314B, it may be necessary to impart an increase amount of energy to the powder while forming a solidification line in a region of the pattern corresponding with 314B. Further, since a distance is less between solidification lines 310 and 315 at a portion of the pattern 314A, it may be necessary to impart a decreased amount of energy to the powder while forming a solidification line in a region of the pattern corresponding with 314A. The amount of energy imparted when forming a solidification line may adjusted by controlling any on one of or the combination of a speed at which the solidification line is formed (i.e. speed at which the energy source is scanned along the powder), the power of the energy beam, and/or the focus of the energy beam. For example, it may be desirable to increase the speed at which the energy source is scanned along the powder at portions 303 and 313 where the distance (e.g. as represented by 314A) between solidification lines is smaller and decrease the speed when forming portions 302, 304, 311, and/or 312 where the distance (e.g. as represented by 314B) between solidification lines is greater. As another example, it may be desirable to decrease the power of the energy source and/or slightly de-focus the energy source in a portions 303 and 313 where the distance 314A between the solidification lines is smaller and increase the power of the energy source and/or re-focus the energy source at portions 302, 304, 311, and/or 312 where the distance 314B between solidification lines is greater. Further, a combination of the two abovementioned methods may also be employed (e.g. a decrease in speed and power). In each of the abovementioned examples, the irradiation energy received by the powder may be varied as a function of distance from the axis about which the pattern oscillates. By using the abovementioned methods, it is possible to control the uniformity of the heat distribution across the layer, or to control the stresses, variance in the build, crystal growth, and/or control/improve microstructure within the material during a build process and/or to improve efficiency of the build process.

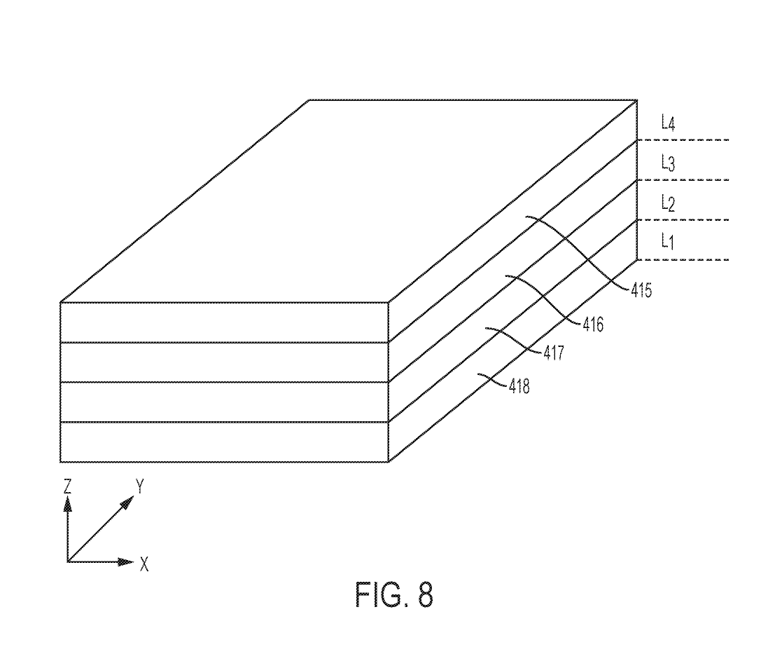

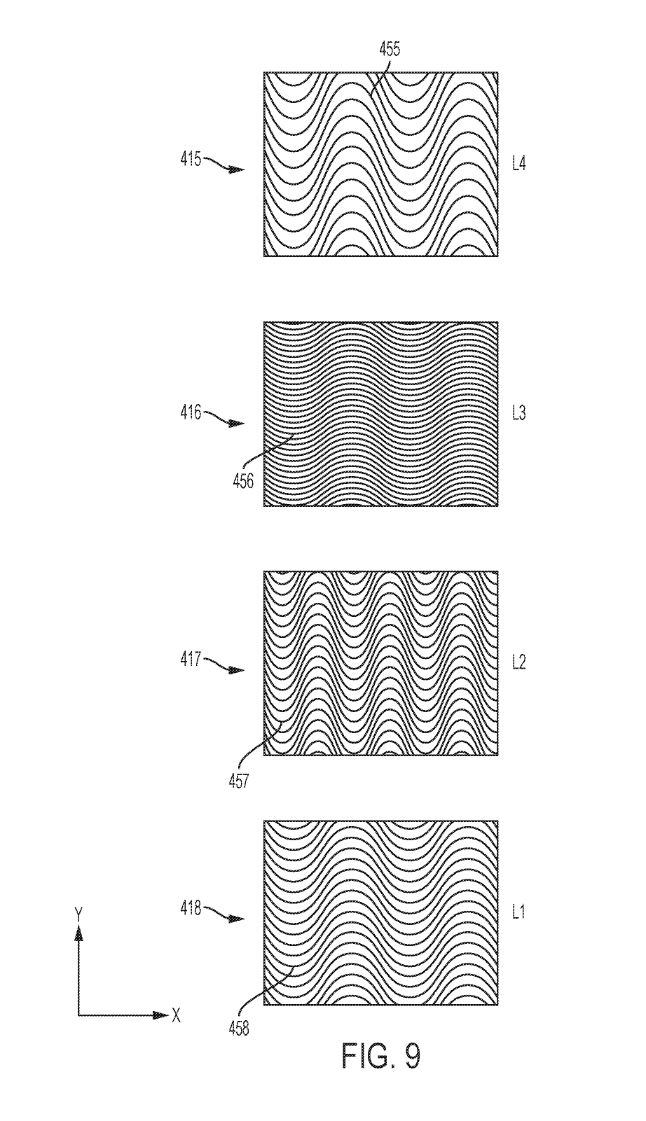

FIGS. 8 and 9, represent the process of building a component using an AM technique in accordance with one embodiment. At least a portion of a component built using an AM technique, an example of which is shown in FIG. 8, comprises a plurality of at least partially fused layers 415, 416, 417, and 418. When forming a first layer 418, a layer of powder is provided. A first layer 418 may be at least partially fused as a series of curved adjacent solidification lines 458. To form each of the adjacent solidification lines 458, an energy source, such as a laser, is scanned across the surface of the powder. The energy source follows at least a first path, wherein the first path is shaped as a first pattern that oscillates about an axis. As mentioned above, the energy source and/or laser may also be controlled so that the heat radiating from the curved solidification line 458 and a subsequent or previous solidification line may cause the thin line of powder between the adjacent solidification lines to melt together, to sinter together without melting and/or to remain unfused. As discussed in detail above, the varying distance between adjacent solidification lines may need to be compensated for to achieve a uniform effect on the material between the solidification lines and/or on the next or subsequent solidification line as discussed above. For example, in a portion of the curved solidification line where the distance is greater between the adjacent solidification lines, the energy imparted into the powder may be increased. Further, in a portion of the curve solidification line where the distance is smaller between the adjacent solidification lines a decreased amount of energy may be imparted into the powder. The amount of energy imparted when forming a solidification line may be adjusted by controlling any on one of or the combination of a speed at which the solidification line is formed (i.e. speed at which the energy source is scanned along the powder), the power of the energy beam, and/or the focus of the energy beam. The irradiation energy received by the powder may be varied as a function of distance from the axis about which the pattern oscillates.

When forming a second layer 417, a layer of powder is provided over the first layer 418. The second layer 418 may be at least partially fused as a series of curved adjacent solidification lines 457. The energy source follows at least a second path, wherein the second path is shaped as a second pattern that oscillates about an axis. The second series of solidification lines 417 may be varied in geometry with respect to the first series of solidification lines 418. As an example, when forming the curved solidification lines along a pattern that is a sinusoidal pattern, any one or a combination of the direction, amplitude, frequency, angular frequency and/or phase of the sinusoidal pattern may be varied with respect to the solidification lines 458 of the first layer of the build. It is also noted that either as an alternative or in combination with the abovementioned variations, the axis about which the oscillating pattern is formed when forming the second series of curved solidification lines 457 may be rotated with respect to the previously formed solidification lines 458.

As each subsequent layer is built (e.g. 416 and 415), the energy source may follow a path that varies from the previous or any subsequently formed layer. For example solidification lines 456 and 455 in subsequent layers 416 and 415 may be formed as a sinusoidal pattern, that may vary in any one or a combination of the direction, amplitude, frequency, angular frequency and/or phase of the pattern of solidification lines formed in any immediate subsequent or previous layer. It is also noted that either as an alternative or in combination with the abovementioned variations, the axis about which the oscillating pattern is formed when forming the curved solidification lines 456 and 455 may be rotated with respect to the previously formed solidification lines. When forming each of the individual curved solidification lines 455, 456, 457, 458, the energy source may be scanned along a path as shown in FIG. 10, for example.

As shown in FIG. 10, when using a laser as an exemplary energy source, a galvanometer scanner may guide the laser over a layer of powder on a component build having a part boundary and/or contour scan 404. The galvanometer scan path may start at 401, and continue subsequently to portions 402, 403, 405, 413, 412, 414, 415, 416 and 417. While a portion of the scan pattern is shown, it is noted that the scan pattern may continue until the entire surface of layer that is desired to be solidified is at least partially melted and solidified. As shown in FIG. 10, the energy source may be turned off, decreased in power, and/or defocused (hereinafter interchangeably referred to as skywriting and/or skywritten) over the path 401, 405, 414, and 417. As an another alternative, which may be used in combination with the abovementioned strategy, portions 402, 403, 413, 412, 415, and 416 may be formed with the energy source connecting each path along a part boundary or contour scan 404 (e.g. without any skywriting). It is noted that the path shown is not exemplary only and variations may be used without departing from the scope of the disclosure, for instance the path may be reversed. It is also noted that multiple energy sources may be used to form portions 402, 412, and 415 simultaneously and subsequently form portions 403, 403, and 416 subsequently as well. Further, it is noted that depending on the geometry of the component being built, skywriting may occur in any portion of the curved solidification line, this example is further discussed below.

As shown in FIG. 11, when using a laser as an exemplary energy source (an electron beam or any other energy source may also be used either alternatively or in combination with a laser), a galvanometer scanner may guide the laser over a layer of powder on a component build having a part boundary and/or contour scans 500 and 504. The galvanometer may form a path beginning at example portion 502, and continue subsequently to portions 503, 526, 505, 506, 520, 516, 513, 512, 501, 514, 530, 524, 536, and 522. While a portion of the scan pattern is shown, it is noted that the scan pattern may continue until the entire surface of layer bounded by 500 and 504 that is desired to be solidified is at least partially melted and solidified. The energy source may be turned off, decreased in power, and/or defocused (hereinafter interchangeably referred to as skywriting and/or skywritten) over the broken line portions of the path (e.g. portions 526, 505, 520, 501, 524, and 522). It is noted that the path shown exemplary only and variations may be used without departing from the scope of the disclosure, for instance the path may be reversed. It is also noted that multiple energy sources may be used to simultaneously form each of the curved solidification lines.

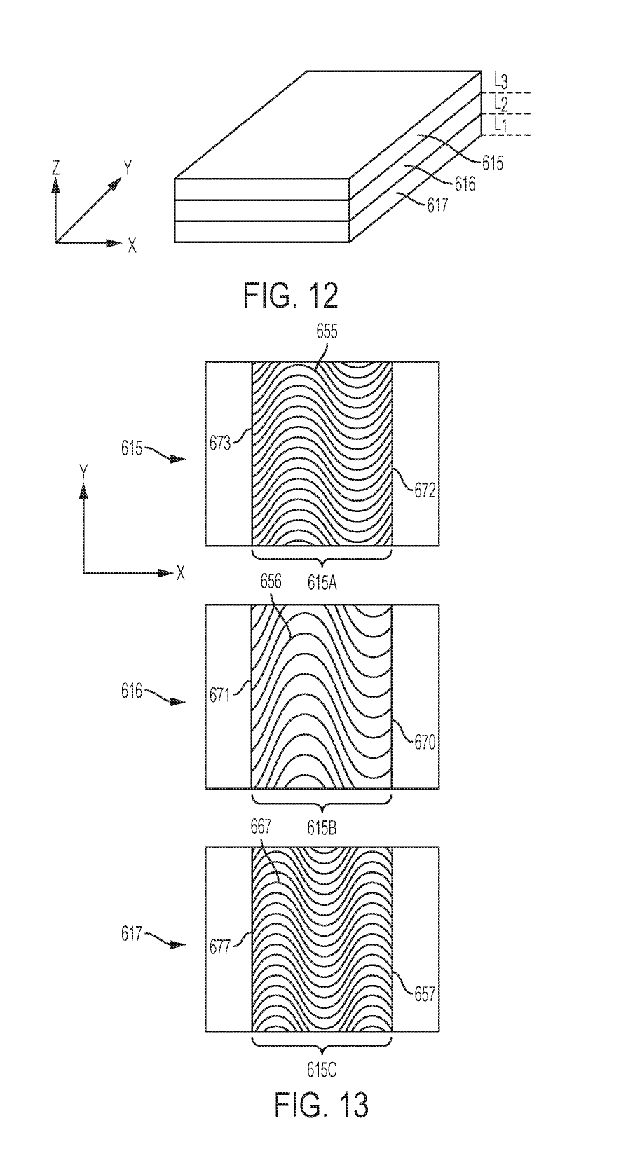

While the abovementioned exemplary scan patterns are formed across the surface of the layer being formed, depending on the desired properties of the completed build and/or time constraints of the build process, it may be desirable to divide up each layer to be built into stripe regions bounded by stripe boundaries. Further examples of stripe regions and boundaries are further disclosed in U.S. patent application Ser. No. 15/451108, titled “Triangle Hatch Pattern for Additive Manufacturing,” with attorney docket number 037216.00070, and filed Mar. 6, 2017 and U.S. patent application Ser. No. 15/451043, titled “Leg Elimination Strategy for Hatch Pattern,” with attorney docket number 037216.00078, and filed Mar. 6, 2017, which are incorporated herein in their entirety. FIGS. 12 and 13, represent the process of building a component using an AM technique in accordance with one embodiment. At least a portion of a component built using an AM technique, an example of which is shown in FIG. 12, comprises a plurality of at least partially fused layers 615, 616, and 717. When forming a first layer 617, a layer of powder is provided. A first layer 617 may be formed as a series of at least partially fused curved adjacent solidification lines 667. The curved solidification lines 667 may include any of the properties discussed throughout the disclosure and may be formed within a stripe region, having stripe width 615C and bounded by stripe boundaries 657 and 677. The stripe boundaries 657 and 677 may represent a boundary in which an energy source is powered; when the scan path of the energy source is outside of the stripe boundaries 657 and 677 the energy source is de-powered. Accordingly, when forming a stripe region, solidification lines are only formed within the stripe boundaries as the stripe region is being formed. As an alternative, the stripe boundaries 657 and 677 may also be at least partially melted and solidified by a laser or energy source and formed as solidification lines either before, after, or during a scan and solidification process within the stripe region. It is noted that since the surface of the component being built may be divided into several stripe regions, each stripe region may be formed individually or several stripe regions may be formed simultaneously (e.g. when multiple energy sources are used).

When forming a second layer 616, a layer of powder is provided over the first layer 616. The second layer 616 may be at least partially fused as a series of curved adjacent solidification lines 656 formed within a stripe region bounded by stripe boundaries 670 and 671. The energy source follows at least a second path, wherein the second path is shaped as a second pattern that oscillates about an axis. The second series of solidification lines 656 may be varied in geometry with respect to the first series of solidification lines 667. As an example, when forming the curved solidification lines along a pattern that is a sinusoidal pattern, any one or a combination of the direction, amplitude, frequency, angular frequency and/or phase of the sinusoidal pattern may be varied with respect to the solidification lines 667 of the first layer of the build. It is also noted that either as an alternative or in combination with the abovementioned variations, the axis about which the oscillating pattern is formed when forming the second series of curved solidification lines 656 may be rotated with respect to the previously formed solidification lines 667. Further, a stripe width may also be varied in the subsequent layer. For example, a stripe width 615B of layer 616 may be narrower or wider than the stripe width 615C of layer 617.

As each subsequent layer is built (e.g. 615), the energy source may follow a path that varies from the previous or any subsequently formed layer. For example solidification lines 655 in subsequent layer 615 may be formed as a sinusoidal pattern, that may vary in any one or a combination of the direction, amplitude, frequency, angular frequency and/or phase of the pattern of solidification lines formed in any immediate subsequent or previous layer. It is also noted that either as an alternative or in combination with the abovementioned variations, the axis about which the oscillating pattern is formed when forming the curved solidification lines 655 may be rotated with respect to the previously formed solidification lines. Further, a stripe width may also be varied in the subsequent layer as discussed above. Further, each of the abovementioned embodiments and scan methods may be used in combination with one another. For instance a layer of the build may be formed using curved solidification lines that span across the entire layer of the build, and a subsequent layer may be formed with curved solidification lines formed within stripe regions.

In an aspect, the present invention relates to the curved solidification pattern used in additive manufacturing techniques which may be of the present invention incorporated or combined with features of other powder bed additive manufacturing methods and systems. The following patent applications include disclosure of these various aspects and their use:

U.S. patent application Ser. No. 15/406,467, titled “Additive Manufacturing Using a Mobile Build Volume,” with attorney docket number 037216.00059, and filed Jan. 13, 2017;

U.S. patent application Ser. No. 15/406,454, titled “Additive Manufacturing Using a Mobile Scan Area,” with attorney docket number 037216.00060, and filed Jan. 13, 2017;

U.S. patent application Ser. No. 15/406,444, titled “Additive Manufacturing Using a Dynamically Grown Build Envelope,” with attorney docket number 037216.00061, and filed Jan. 13, 2017;

U.S. patent application Ser. No. 15/406,461, titled “Additive Manufacturing Using a Selective Recoater,” with attorney docket number 037216.00062, and filed Jan. 13, 2017;

U.S. patent application Ser. No. 15/406,471, titled “Large Scale Additive Machine,” with attorney docket number 037216.00071, and filed Jan. 13, 2017.

The disclosures of the above listed applications are incorporated herein in their entirety to the extent that they disclose additional aspects of powder bed additive manufacturing methods and systems that can be used in conjunction with those disclosed herein.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. Aspects from the various embodiments described, as well as other known equivalents for each such aspect, can be mixed and matched by one of ordinary skill in the art to construct additional embodiments and techniques in accordance with principles of this application.

What is claimed is:

1. A method for fabricating an object, comprising:
(a) irradiating a portion of a given layer of powder to form a fused region;
(b) providing a subsequent layer of powder over the given layer of powder; and
(c) repeating steps (a) and (b) until the object is formed, wherein the fused region is formed by irradiating a first portion of a layer of powder with an energy beam, the fused region comprising:
adjacent curved solidification lines, wherein each of the adjacent curved solidification lines is formed in a first pattern that oscillates about an axis.

2. The method for fabricating an object of claim 1, wherein each of the adjacent curved solidification lines formed in the first pattern are sinusoidal.

3. The method for fabricating an object of claim 1, wherein the energy beam comprises at least one electron-beam.

4. The method for fabricating an object of claim 1, wherein energy beam comprises at least one laser.

5. The method for fabricating an object of claim 1, wherein the adjacent curved solidification lines are formed within a boundary region, wherein the boundary region is at least partially defined by the edge of the object.

6. The method for fabricating an object of claim 1, wherein the adjacent curved solidification lines are formed within a boundary region, wherein the boundary region is at least partially defined by a contour of the object being fabricated.

7. The method for fabricating an object of claim 1, wherein the adjacent curved solidification lines are formed within a boundary region, wherein the boundary region is at least partially defined by a linear stripe.

8. The method of fabricating an object of claim 1, wherein forming each of the adjacent curved solidification lines in the first pattern further comprises:
scanning the energy beam across the powder along the first pattern, wherein the irradiation energy received by the powder is varied as a function of distance from the axis.

9. The method for fabricating an object of claim 1, further comprising:
providing a subsequent layer of powder over the first portion;
irradiating a second portion of the subsequent layer of powder to form a fused region in the second portion, wherein fused region of the second portion further comprises:
adjacent curved solidification lines, wherein each of the adjacent curved solidification lines is formed in a second pattern that oscillates about an axis, wherein the geometry of the second pattern is different from the geometry of the first pattern.

10. The method of fabricating an object of claim 9, wherein forming each of the adjacent curved solidification lines in the second pattern further comprises:
scanning the energy beam across the powder along the second pattern, wherein the irradiation energy received by the powder is varied as a function of distance from the axis.

11. The method for fabricating an object of claim 9, wherein each of the adjacent curved solidification lines formed in the second pattern are sinusoidal.

12. A system comprising an additive manufacturing device for irradiating a powder, a monitoring device, a computer, and software integrated together to adjust irradiation settings in the additive manufacturing device, wherein the system irradiates at least a portion of a layer of powder to form a fused region, wherein the fused region is formed by irradiating a first portion of a layer of powder with an energy beam, the first portion of the layer further comprising:
adjacent curved solidification lines, wherein each of the adjacent curved solidification lines is formed in a first pattern that oscillates about an axis.

13. The system of claim 12, wherein the system:
provides a subsequent layer of powder over the first portion;
irradiates a second portion of the subsequent layer of powder to form a fused region in the second portion, wherein fused region of the second portion further comprises:
adjacent curved solidification lines, wherein each of the adjacent curved solidification lines is formed in a second pattern that oscillates about an axis, wherein the geometry of the second pattern is different from the geometry of the first pattern.

14. The system of claim 12, wherein the system scans the energy beam across the powder along the first pattern, wherein the system varies the irradiation energy received by the powder as a function of distance from the axis.

15. The system of claim 12, wherein each of the adjacent curved solidification lines formed in the first pattern are sinusoidal.

16. The system of claim 13, wherein each of the adjacent curved solidification lines formed in the second pattern are sinusoidal.

17. The system of claim 12, wherein the system irradiates the powder using at least one electron-beam.

18. The system of claim 12, wherein the system irradiates the powder using at least one laser.

19. The system of claim 12, wherein the system forms the adjacent curved solidification lines within a boundary region, wherein the boundary region is at least partially defined by the edge of the object.

20. The system of claim 12, wherein the system forms the adjacent curved solidification lines within a boundary region, wherein the boundary region is at least partially defined by a contour scan.

21. The system of claim 12, wherein the system forms the adjacent curved solidification lines within a boundary region, wherein the boundary region is at least partially defined by a linear stripe.
